(19) United States
(12) Patent Application Publication
(10) Pub. No.: US 2009/0090450 A1
(43) Pub. Date: Apr. 9, 2009

(54) Red White Blue Black Camouflage System

(76) Inventor: Martin Charles Boire, Port Orange, FL (US)

Correspondence Address: Martin C. Boire, P. O. Box 30, Daytona Beach, FL, 32128, US

(21) Appl. No.: 12/245,302

(22) Filed: Oct. 3, 2008

Related U.S. Application Data
(60) Provisional application No. 60/977,644, filed on Oct. 4, 2007.

(51) Int. Cl. B44C 3/12

(52) U.S. Cl. 156/63

(57) ABSTRACT

A camouflage system that allows distinctly unnatural colors to be worn without comprising the ability of the user to blend into natural surroundings. Shading is used not only as borders between cells of color, but moreover, shading is used in various degrees to force commonality of color between colors that are normally strikingly contrasting.

Reference to Provisional Application is 60/977,644, filed Oct. 4, 2007.

### FIELD OF THE INVENTION

The present invention is concerned with camouflage; and more particularly, the present invention is a colored camouflage system that allows one to not only display unique coloring, but also provides for masking the distinct colors from an animal's vision.

### BACKGROUND OF THE INVENTION

Americans love hunting. When hunting, they usually wear camouflage, which provides them with visual protection from being attacked by wild animals. No hunter wants to be chased by a moose, and if camouflage helps a hunter to blend in with nature, then animals cannot easily identify the hunter and attack the hunter.

Camouflage is not just worn for safety reasons, but a hunter is able to hunt more effectively if the hunter is not seen by his prey. Animals routinely rely on their eyes and ears to discern whether danger is lurking. With a hunter approaching prey while the hunter is clad in typical street clothes, the hunter stands out in stark contrast against the flora.

Typical camouflage easily blends with nature due to its nature-based colors and its pattern. To create typical camouflage, three distinct colors are arranged into separate cells. The three distinct cell concept is an effective method for creating camouflage because colors in nature easily blend with nature-based colors of the camouflage.

Obviously, the colors red, white and blue are not a good combination because they are not nature-based colors. Further, they are not easy to blend, and instead create stark contrast when placed against each other. While animals typically cannot see bright colors, they can easily spot the separations and stark contrasts of red, white, and blue camouflage because such colors placed together are not common in nature. Moreover, some animals can see colors particularly well—so that sections of red, white, and blue next to one another clearly look out of place in nature.

The problem is that red, white, and blue camouflage is desirable for a variety of reasons. First, people can see red, white, and blue camouflage on other hunters—so red, white, and blue camouflage is excellent for safety to avoid one hunter shooting another hunter. Second, red, white, and blue camouflage is obviously formed of patriotic colors; and there is a desire in some hunters to be able to display their patriotism while hunting by simply wearing red, white, and blue camouflage.

Thus, there is a need for red, white, and blue camouflage that can be worn by hunters, but that is advanced in some sort of way to prevent easy visual detection by animals.

### SUMMARY OF THE INVENTION

The present invention is a camouflage system that allows red, white, and blue camouflage to be worn without making the hunter stand out in stark contrast to nature—at least in an animal's eyes.

In regular camouflage, the color in a cell is uniform or flat across the entire surface area of the cell. The present invention differs from regular camouflage in that each cell is individually shaded starting on one side and moving across the entire cell.

Unlike pixilated camouflage, the present invention does not attempt to splice blocks of color next to other blocks of color. Pixilated camouflage might attempt to make coloration not so obvious to the eyes, but all that pixilated camouflage does is to place smaller units of color next to other units of color. There is still separation of color that occurs, and the separation of color is exactly that which allows the camouflage to appear unnatural in comparison to natural surroundings. The present invention avoids the unnatural look.

In the present invention, each cell's shading is dependent upon and modeled after a neighboring cell's shading—not merely a random cell of coloring. Second, the color black is then applied uniformly as a further gradient to each of the red, white and blue cells in order to act as a unifying element. The gradient is applied in different angles, with different densities, and with differing concentrations across each cell.

### DETAILED DESCRIPTION OF THE PREFERRED EMBODIMENT(S)

In the present invention, sometimes there will be a higher concentration of the color black at the left end of a cell than at the right end and vice versa. Moreover, sometimes the biggest concentrations of the black gradient will be in the middle of a specific cell. This second step ties the separate colors together by giving them a color in common—the black shading—and is the critical step to making these three distinct colors blend better with nature and between themselves. As a result, this type of camouflage is less perceptible to animals because the dark and light colors blend together more naturally.

A thick border between the cells may also be employed in order to carve the cells into separate units. This cell border may contain the shading or gradient within itself as well. The units can resemble shapes in nature, and the shading—acting as the blending color tying the cells together naturally—blends into the borders of various thicknesses of cell borders.

While the black gradient is the most common color used in this process, other colors can also be utilized. However, sometimes they may need to be used in different proportions and patterns. The entire blended pattern may further be printed on fabrics or materials of different background colors, such as denim, to further the blending effect, although white is the most commonly used color.

I claim:

1. A method of camouflage design, comprising:
taking colors red, white and blue;
organizing the colors into cells, creating a camouflage pattern; and
placing the camouflage pattern on fabric.

2. The method of claim 1, wherein each said cell is individually shaded throughout in its entirety.

3. The method of claim 2, wherein cell's shading is dependent upon and modeled after their neighboring cell's shading.

4. The method of claim 1, further comprising applying a single dark color to each individual cell as a further gradient, further unifying neighboring surrounding cells.

5. The method of claim 4, wherein said fabric can be paper or metal.
